(19) United States
(12) Patent Application Publication
(10) Pub. No.: US 2014/0040725 A1
(43) Pub. Date: Feb. 6, 2014

(54) SYSTEM AND METHOD FOR DISPLAYING AN RSS FEED ON AN ELECTRONIC DISPLAY

(71) Applicants: Brian Foster, Plainfield, IL (US); Jesse W. Nual, Plainfield, IL (US); April Wilson, Mooresville, NC (US); Robert Wright, Myrtle Beach, SC (US); Jonathan Higgins, Myrtle Beach, SC (US)

(72) Inventors: Brian Foster, Plainfield, IL (US); Jesse W. Nual, Plainfield, IL (US); April Wilson, Mooresville, NC (US); Robert Wright, Myrtle Beach, SC (US); Jonathan Higgins, Myrtle Beach, SC (US)

(21) Appl. No.: 13/959,296

(22) Filed: Aug. 5, 2013

Related U.S. Application Data
(60) Provisional application No. 61/679,349, filed on Aug. 3, 2012.

(51) Int. Cl. G06F 17/22

(52) U.S. Cl. CPC G06F 17/2247
USPC 715/234

(57) ABSTRACT

An electronic billboard comprises at least one processor, at least one computer-readable tangible storage device, and program instructions stored on the at least one storage device for execution by the at least one processor. The program instructions comprise first program instructions configured to receive media content comprising text and at least one image. The program instructions further comprise second program instructions configured to separate the text and the at least one image. The program instructions further comprise third program instructions configured to cause the electronic billboard to display the text on a first predetermined portion of the electronic billboard. The program instructions further comprise fourth program instructions configured to cause the electronic billboard to display the image on a second predetermined portion of the electronic billboard.

### CROSS-REFERENCE TO RELATED APPLICATIONS

This application claims priority from U.S. Provisional Patent Application No. 61/679,349, filed on Aug. 3, 2012, which is incorporated by reference herein in its entirety.

### FIELD OF INVENTION

The present disclosure relates to the field of electronic displays. More particularly, the present disclosure relates to a system and method for displaying RSS feeds on an electronic display.

### BACKGROUND

Billboards are used as advertising platforms for delivering specific messages at specific locations. Static billboards contain a single message and must be physically altered on location to display a new advertisement message. A digital billboard includes an electronic display that enables a systems administrator to change the advertisement message without physically altering the billboard. For example, a digital billboard may be connected to a wired or wireless network and may be accessible remotely via a computer. A plurality of advertisements may be stored in a database accessible by the remote computer, and transferred to the billboard.

Creating an advertisement message may be complex and time consuming, because graphic design and publishing software tools often require advanced technical knowledge. Additionally, transferring the updated message to the billboard may be time consuming and may involve multiple functions executed by multiple participants. Also, it may be complex and time consuming for an advertiser to create multiple advertisement campaigns.

### SUMMARY OF THE INVENTION

A system comprises at least one processor, at least one computer-readable tangible storage device, and program instructions stored on the at least one storage device for execution by the at least one processor. The program instructions comprise first program instructions configured to receive a notification indicative of data submitted for approval. The program instructions further comprise second program instructions configured to automatically publish the data to an RSS feed responsive to the data being approved. The program instructions further comprise third program instructions configured to receive the RSS feed. The program instructions further comprise fourth program instructions configured to display the data at a display.

In a method for displaying an RSS feed at an electronic display, a computer receives a notification indicative of data submitted for approval. A computer automatically publishing the data to an RSS feed responsive to the data being approved. A computer receives the RSS feed. A computer causes the electronic display to display the data.

An electronic billboard comprises at least one processor, at least one computer-readable tangible storage device, and program instructions stored on the at least one storage device for execution by the at least one processor. The program instructions comprise first program instructions configured to receive media content comprising text and at least one image. The program instructions further comprise second program instructions configured to separate the text and the at least one image. The program instructions further comprise third program instructions configured to cause the electronic billboard to display the text on a first predetermined portion of the electronic billboard. The program instructions further comprise fourth program instructions configured to cause the electronic billboard to display the image on a second predetermined portion of the electronic billboard.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example system for displaying an RSS feed on an electronic billboard.

FIG. 2 illustrates a screen shot of an example application for submitting content to be received by at a digital billboard as an RSS feed.

FIG. 3 illustrates a block diagram of example system for displaying an RSS feed on an electronic billboard in more detail.

FIG. 4 illustrates example channels and corresponding design shells for use in an example system for displaying an RSS feed on an electronic billboard in more detail.

FIG. 5 is a flow chart illustrating the steps of an example method for displaying an RSS feed on an electronic billboard.

FIG. 6 illustrates a block diagram of an example computing system for implementing an example system for displaying an RSS feed on an electronic billboard.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computing device,” as used herein, refers to a laptop computer, a desktop computer, a smartphone, a personal digital assistant, a cellular telephone, a tablet computer, or the like.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners.

Suitable software for implementing the various components of the example systems and methods described herein may be produced using programming languages and tools like Haskell, Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

A system for displaying a Really Simple Syndication (“RSS”) feed on an electronic billboard is described herein. An image and text are created with an application enabled device such as a smart phone or tablet computer, and published to a web site for approval. Once approved, the image and text are combined into a single RSS feed and scheduled for transfer to a billboard. After the RSS feed is transferred to an electronic billboard, the combined RSS feed is split into two feeds and loaded into predefined template placeholders at the billboard. This system seamlessly allows for updating a billboard from a mobile device in near real time.

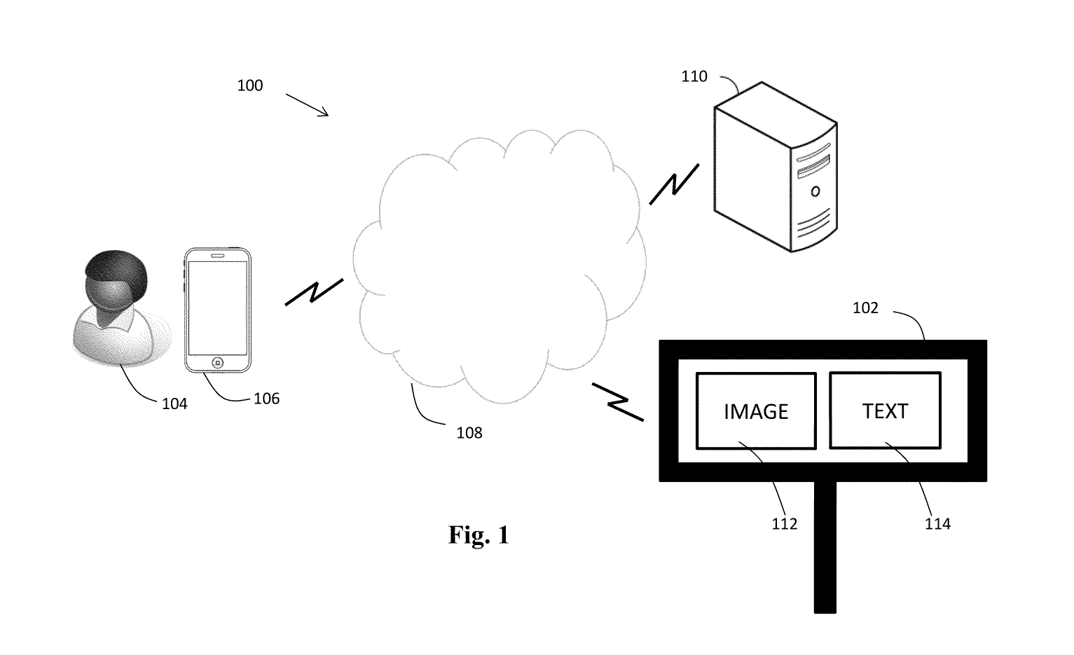

FIG. 1 illustrates an example system 100 for displaying an RSS feed on a digital billboard 102. The example system 100 enables a user 104 to update a digital billboard 102 with both text and graphics using a mobile computing device 106 such as a mobile phone, via a network 108. Display server 110 enables a systems administrator to configure digital billboard 102 to display content received via the RSS feed. Thus, user 104 is able to quickly update digital billboard 102 with time sensitive advertising material to better target an audience at precise moments. For example, user 104 may decide to have a last minute lunch special at a restaurant and offer a 50% discount on hamburgers for the next one hour time period. Using the example system 100, user 104 is able to create the advertisement to promote the special by describing the discount and including an image of the hamburger, using mobile device 106. User 104 is then able to feed the new advertisement to the digital billboard 102 to communicate the special to potential customers. After the hour passes, user 104 is able to immediately update the digital billboard 102 to reflect a new special or to simply revert the display a standard default advertisement. In another example, the user 104 is able provide a new advertisement to the digital billboard 102 and set a time period for the new advertisement to be displayed. At the end of the time period, the billboard can revert the display a standard default advertisement.

The example system 100 also enables user 104 to generate multiple marketing campaigns to target different audiences or markets. For example, an auto dealer may utilize two marketing channels, one to target new car buyers and one to target used car buyers. Using the example system 100, the auto dealer may target either channel with a custom message according to current market conditions or market needs. For example, if the market experiences an increase in new car sales, the auto dealer can display messages using the example system 100 that are directed to new car buyers. Conversely, if the market experiences an increase in used car sales, the auto dealer can display messages using the example system 100 that are directed to used car buyers.

It should be understood that, although some of the example systems and methods described herein refer to displaying an RSS fee on digital billboard 102, similar systems and methods may be used to display an RSS feed on other suitable digital display devices such as a kiosk, a monitor, and so on.

With continued reference to FIG. 1, mobile device 106 is configured to enable user 104 to create an advertisement, a marketing message, or other suitable message using an application on a mobile device 106. It should be understood that although the example system is described to include a mobile device 106 for user 104 interaction, other suitable client devices such a personal computer, a laptop computer, or a tablet computer can be used as well.

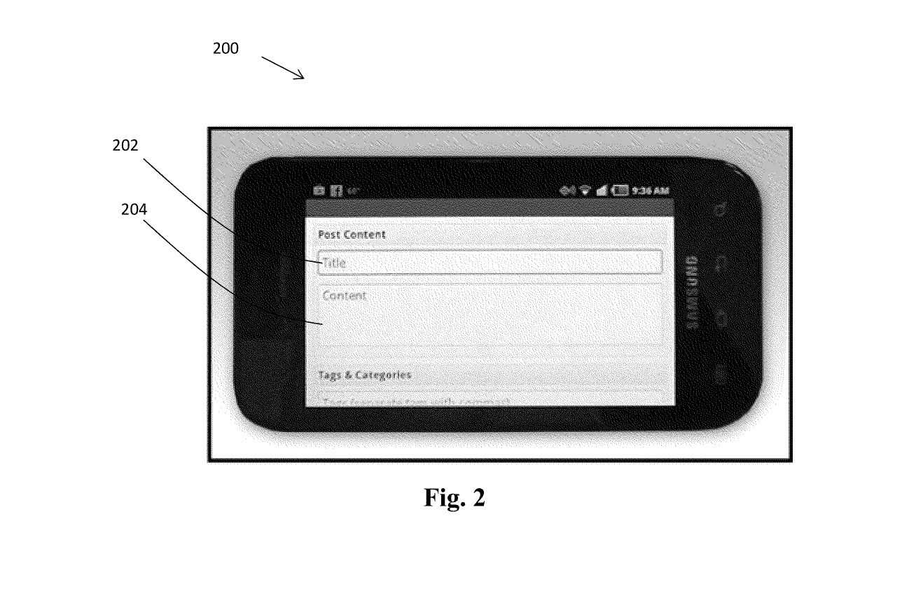

An application on the mobile device 106 is configured to enable user 104 to enter text as well as graphics. FIG. 2 illustrates an example screen shot 200 of an example application configured to be executed on mobile device 106. User 104 may download and install the application for creating content via any suitable means. For example, user 104 may download the application from display server 110, from a third party server via network 108 such as Apple's App Store, or from a CD.

The application includes a Title field 202 for entering text to be displayed on digital billboard 102. The application also includes a Content field 204 for attaching an image to be displayed on the digital billboard 102. An image can be selected as an existing image file previously saved on the client device or otherwise accessible by the client device. If mobile device 106 has a built-in camera, the graphic may be captured in real time. This may be beneficial if, for example, user 104 wants to display on digital billboard 102 a picture of a happy customer who won a jackpot at a casino. User 104 may take a picture of the happy customer with mobile device 106 and prepare an advertising message including the picture of the happy customer for display on digital billboard 102 immediately following the event.

The downloaded application requires user 104 to add URL information and other appropriate information necessary to configure the application to communicate with display server 110. Once properly configured, user 104 may proceed to create content and transfer the content to display server 110 for approval.

After the marketing message is generated by user 104, the application on mobile device 106 generates a notification to be sent via network 108 to a systems administrator for approval. In one example, the notification is an email. It should be understood that approval may be performed by a human, or automatically by display server 110. For example, display server 110 may be configured to review the notification to ensure that content created and submitted by user 104 meets certain technical specifications. Predefine specifications may require a picture to have a minimum resolution, or for text to include fewer than a maximum number of characters, for example. Display server 110 may also be configured to review the submitted content to ensure that the content meets other standards. For example, display server 110 may have a policy against profanity or against copyright infringement. Display server 110 may also proofread the text of the submitted content. Approval may be based on any standard, and the scenarios stated above are not intended to be limiting.

In one example, display server may provide an interface for enabling an administrator to approve content. For example, an administrator may approve the submitted content by changing a category, or a status, of the message from inactive to social, or active. In another example, the administrator may approve the message by clicking an approve button in an application interface or by other suitable means.

Display server 110 is further configured to convert the marketing message or other media content submitted by user 104 into an RSS feed. The submitted content may include text only, a graphic only, or both text and a graphic. In the latter case, display server 110 is configured to combine the text and the graphic into a single RSS feed. Specifically, display server 110 is configured to combine text and an image into a single RSS feed using a <media> tag. The <media> tag is an HTML tag that indicates that an image has been embedded within the text of the RSS feed.

It should be understood that, although display server 110 is described herein as being configured to perform various functions, display server 110 may comprise one or more software application servers or other suitable software applications for performing the described functions. In one example, display server 110 comprise one or more computer servers. Accordingly, display server 110 may be configured to receive the submitted content either before or after the content is approved. In an alternative embodiment, display server 110 may be configured to process the submitted content without requiring approval and without performing automatic approval.

Display server 110 is further configured to publish and share the RSS feed via a social web site. The social web site may be a custom branded web site designed specifically for the advertiser to deliver messages to targeted audiences. From the social web site, the message can be linked to the advertisers primary web site, or used as an advertisement on any web site. The message can also be shared by the advertiser or by customers on social network websites such as Facebook.

Display server 110 is further configured to deliver the generated RSS feed to digital billboard 102. In one example, display server 110 is configured to deliver the RSS feed to digital billboard 102 via a channel corresponding to a marketing theme. The channel may be one of a plurality of channels and the marketing theme may be one of a plurality of marketing themes. Digital billboard 102 includes logic configured to subscribe to and receive the RSS feed. Digital billboard 102 further includes logic configured to divide the combined RSS feed into text and an image and to displayed both accordingly. Specifically, digital billboard 102 is configured to receive the single RSS feed and split the feed into two separate feeds, by identifying the <media> tag, before incorporating the message into the billboard template. In one example, the functions of receiving the RSS feed, splitting the feed, and populating a template are performed by display server 110.

Example categories of messages that digital billboard 102 is configured to display include; live updates that allow advertisers to get messages to consumers in near real time, including announcements; images of satisfied customers as events are unfolding; time sensitive alerts and contests; various marketing and branding messages; and news or other information.

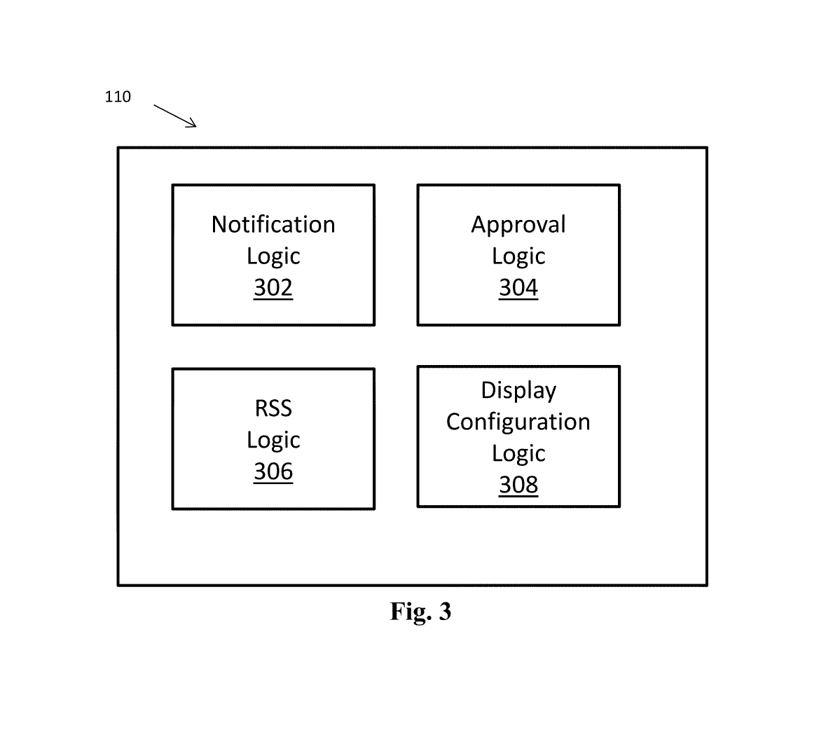

FIG. 3 illustrates an example block diagram of display server 110. Display server 110 includes notification logic 302 configured to receive a notification indicative of data submitted for approval. Display server 110 further includes approval logic 304 configured to automatically approve submitted data. Display server 110 further includes RSS logic 308 configured to automatically publish the data to an RSS feed responsive to the data being approved.

Prior to receiving an RSS feed, digital billboard 102 must be configured appropriately. Accordingly, display server 100 includes display configuration logic 308 configured to enable a systems administrator to configure digital billboard 102. Display configuration logic 308 enables an administrator to designate a digital billboard shell type and add a template with fields, or place holders for receiving dynamic content, to the digital billboard shell. A place holder is a space reserved on digital billboard 102 for displaying the content received via the RSS feed. A template may include a single placeholder configured for displaying text. The template's single place holder may also be configured to display an image. In another example, as illustrated in FIG. 1, the template may include two placeholders 112, 114, where a first placeholder 112 is configured to display an image, and a second placeholder 112 is configured to display text. In another example, the template can include two or more placeholders, where each placeholder 112, 114 can be configured for displaying either text or an image. Thus, digital billboard 102 may be configured to receive and display an RSS feed containing multiple images and multiple text strings.

User 104 may decide whether to create an advertising message containing text, an image, or both. RSS logic 306 automatically routs the RSS feed containing the content to a proper channel associated with digital billboard 102 based on the content, once the message is approved. In one example, user 104 authoring the content for display on digital billboard 102 may also administer digital billboard 102 via display server 110 and may also approve the content for publishing.

Display configuration logic 308 is further configured to enable an administrator to create a web site for the advertiser and establishes an RSS/XML feed for the web site. Display configuration logic 308 is further configured to enable an administrator establish a user role, granting the advertiser proper credentials to access the system. Display configuration logic 308 is further configured to enable an administrator to configure digital billboard to receive the established RSS feed.

Display configuration logic 308 is further configured to enable an administrator to design the look of digital billboard 102 and to enable user 104 to determine how digital billboard 102 displays the RSS feed. For example, display configuration logic 308 enables an administrator to adjust various settings, such as color and font, before previewing and finalizing the billboard display.

Display configuration logic 308 is configured to enable an administrator to create a shell, including basic artwork for digital billboard 102. A shell includes dynamic content placeholders which can be customized for specific users. Display configuration logic 308 is further configured to enable an administrator to schedule or assign the shell to a designated digital billboard 102 for displaying submitted content. In one example, digital billboard 102 may also be associated with a customer's website.

In one example, digital billboard 102 may have multiple shells or templates associated with multiple channels. A website can be associated with multiple marketing channels for a client. Each channel is associated with a single marketing theme. Within the channel, an advertiser can run numerous messages or marketing campaigns for that theme.

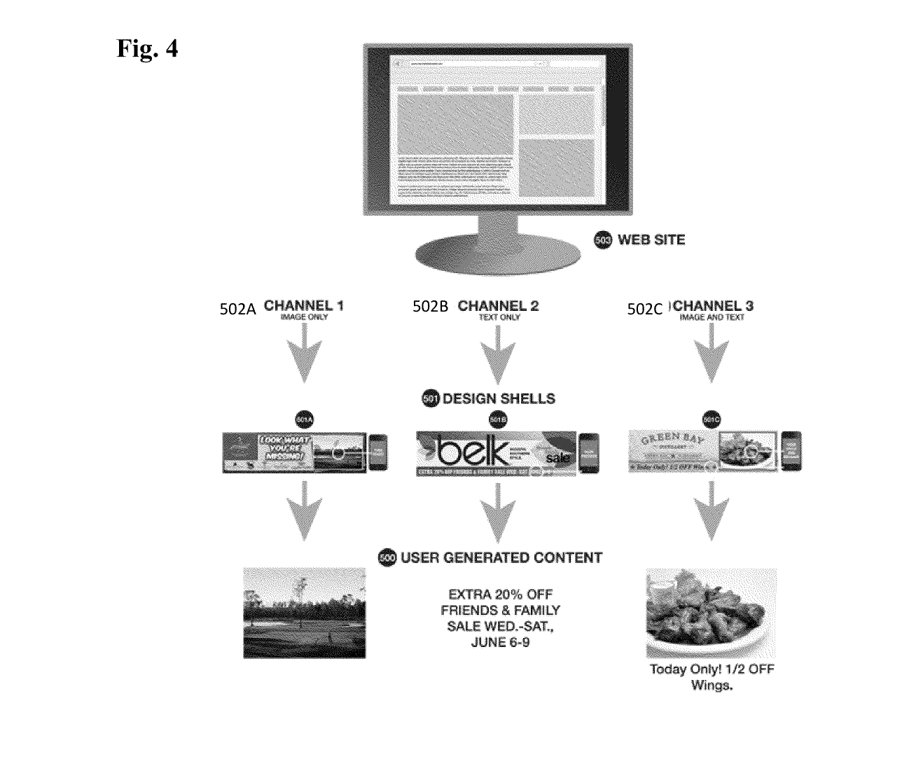

FIG. 4 illustrates example design shells 501A-C for channels 1-3 502A-C. In the examples illustrated, channel 1 502A is used by an advertiser for an ad campaign including a custom image only. A corresponding design shell 501A includes basic artwork and a placeholder for receiving a custom image. Accordingly, in an example ad campaign for a golf course, user generated content 500 on channel 1 may include an image of a golf course. Chanel 2 502B is used by an advertiser for an ad campaign including custom text. A corresponding design shell 501B includes basic artwork and a placeholder for receiving custom text. Accordingly, in an example ad campaign for a retailer, user generated content 500 on channel 2 may include the text “EXTRA 20% OFF FRIENDS & FAMILY SALE WED.-SAT., JUNE 6-9”. Channel 3 502C is used by an advertiser for an ad campaign including both a custom image and custom text. A corresponding design shell 501C includes basic artwork and a placeholder for receiving a custom image as well as a placeholder for receiving custom text. Accordingly, in an example ad campaign for a restaurant, user generated content 500 on channel 3 may include the text “Today Only! ½ Off Wings” as well as a picture of the chicken wings.

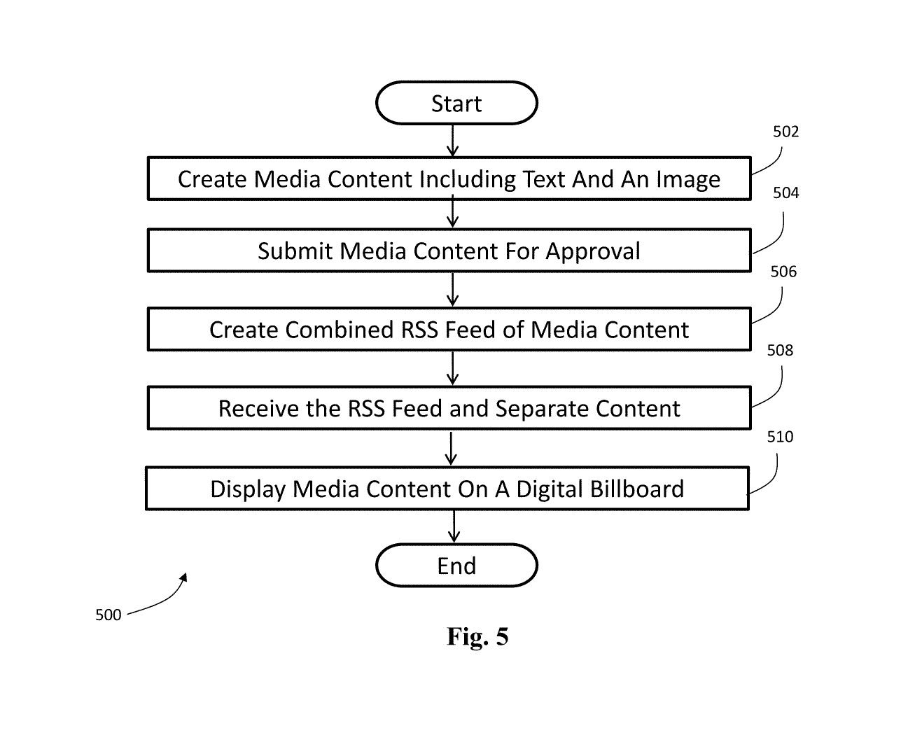

FIG. 5 is a flow chart illustrating the steps of an example method for displaying an RSS feed on a digital billboard. At step 502, a user creates media content including text and an image for display on a digital billboard. At step 504, the user submits the content for approval. At step 506, once the submitted content is approved, the image and the text are combined into a single RSS feed and published to a website. At step 508, a digital billboard subscribed to receive the RSS feed receives the feed and separates the feed into a text portion and an image. At step 510, the text and the image are populated in respective fields of a template associated with the digital billboard and displayed on the billboard.

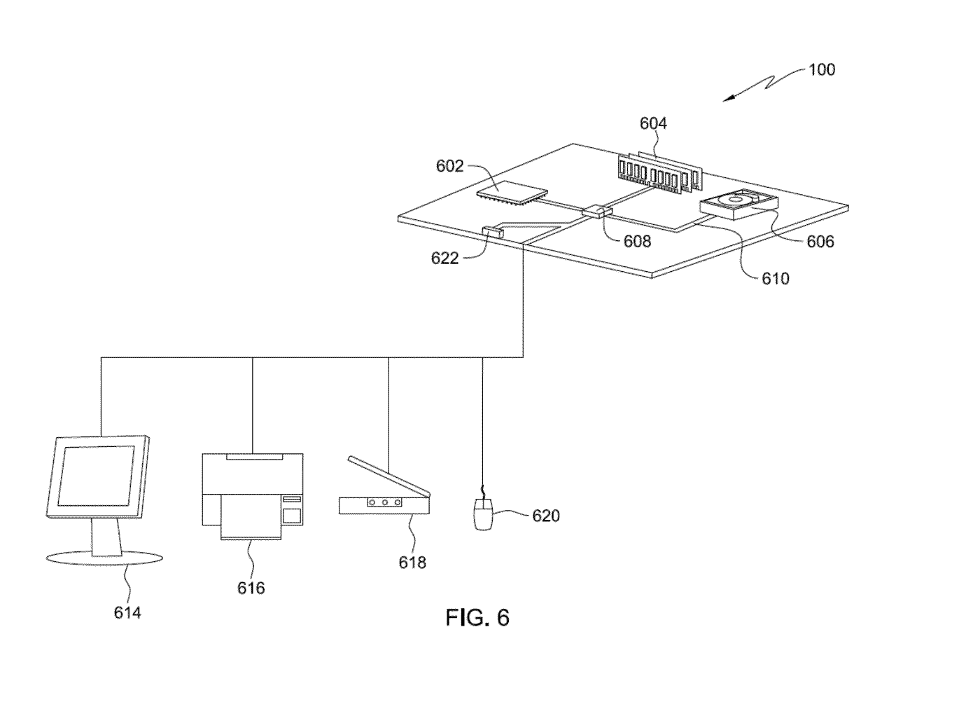

FIG. 6 is a block diagram of an example computing system 600 for implementing an example system for displaying an RSS feed on a digital billboard. The example computing system 600 is intended to represent various forms of digital computers, including laptops, desktops, handheld computers, smartphones, tablet computers, servers, and other similar types of computing devices. As shown, computing system 600 includes a processor 602, memory 604, a storage device 606, and a communication port 608, operably connected by an interface 610 via a bus 612.

Processor 602 processes instructions, via memory 604, for execution within computing system 600. In an example embodiment, multiple processors along with multiple memories may be used.

Memory 604 may be volatile memory or non-volatile memory. Memory 604 may be a computer-readable medium, such as a magnetic disk or optical disk. Storage device 606 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 604 or storage device 606.

Computing system 600 may be coupled to one or more input and output devices such as a display 614, a printer 616, a scanner 618, and a mouse 620.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A system comprising at least one processor, at least one computer-readable tangible storage device, and program instructions stored on the at least one storage device for execution by the at least one processor, the program instructions comprising:
first program instructions configured to receive a notification indicative of data submitted for approval;
second program instructions configured to automatically publish the data to an RSS feed responsive to the data being approved;
third program instructions configured to receive the RSS feed; and
fourth program instructions configured to display the data of the RSS at a display.

2. The system of claim 1, wherein the fourth program instructions are further configured to display the data at a billboard.

3. The system of claim 1, wherein:
the data comprises text and at least one image;
the second program instructions are further configured to combine the text and the at least one image into a single RSS feed; and
the fourth program instructions are further configured to extract from the single RSS feed the text and the at least one image and to display the text and the at least one image at the display.

4. The system of claim 3, wherein:
the second program instructions are further configured to combine the text the at least one image into the single RSS feed by including in the text a predefined html tag indicative of the embedded at least one image; and
the fourth program instructions are further configured to extract from the RSS feed the text and the at least one image by identifying the predefined HTML tag.

5. The system of claim 1, wherein the program instructions further comprise fifth program instructions configured to approve the data, wherein approving the data comprises at least one of determining that the text comprises less than a predefined number of characters and determining that the image comprises a resolution greater than a predefined resolution.

6. The system of claim 1, wherein the first program instructions are configured to receive the notification via an email.

7. The system of claim 1, wherein the second program instructions are further configured to publish the data to a website.

8. The system of claim 1, wherein the fourth program instructions are further configured to populate a place holder of a display template with the data.

9. The system of claim 8, wherein the fourth program instructions are further configured to populate a placeholder of one of a plurality of display templates based on content of the data.

10. A method for displaying an RSS feed at an electronic display, the method comprising the steps of:
a computer receiving a notification indicative of data submitted for approval;
a computer automatically publishing the data to an RSS feed responsive to the data being approved;
a computer receiving the RSS feed; and
a computer causing the electronic display to display the data.

11. The method of claim 10, wherein the step of the computer causing an electronic display to display the data comprises the computer causing a billboard to display the data.

12. The method of claim 10, wherein:
the data comprises text and at least one image;
the step of the computer automatically publishing the data to an RSS feed comprises the computer combining the text and the at least one image into a single RSS feed; and
the step of the computer causing the electronic display to display the data comprises the computer extracting from the single RSS feed the text and the at least one image and the computer causing the electronic display to display the text and the at least one image.

13. The method of claim of claim 12, wherein:
the step of the computer combining the text and the at least one image into a single RSS feed comprises the computer including in the text a predefined HTML tag indicative of the embedded at least image; and
the step of the computer causing the electronic display to display the data comprises the computer extracting from the single RSS feed the text and the at least one image by identifying the predefined HTML tag.

14. The method of claim 10, further comprising the step of a computer approving the data by at least one of determining that the text comprises less than a predefined number of characters and determining that the image comprises a resolution greater than a predefined resolution.

15. The method of claim 10, wherein the step of receiving a notification comprises receiving an email.

16. The method of claim 10, further comprising the step of publishing the data to a website.

17. The method of claim 10, wherein the step of the computer causing the electronic display to display the data comprises the computer populating a place holder of a display template with the data.

18. The method of claim 10, wherein the step of the computer causing the electronic display to display the data comprises:
the computer selecting one of a plurality of channels based on the content of the data, each channel being associated with a display template; and
the computer populating a place holder of a display template associated with the selected channel with the data.

19. An electronic billboard comprising at least one processor, at least one computer-readable tangible storage device, and program instructions stored on the at least one storage device for execution by the at least one processor, the program instructions comprising:
first program instructions configured to receive media content comprising text and at least one image;
second program instructions configured to separate the text and the at least one image;
third program instructions configured to cause the electronic billboard to display the text on a first predetermined portion of the electronic billboard; and
fourth program instructions configured to cause the electronic billboard to display the image on a second predetermined portion of the electronic billboard.

20. The electronic billboard of claim 19, wherein:
the first program instructions are configured to receive the media content in the form of an RSS feed; and
the second program instructions are configured to separate the text and the at least one image by identifying a predefined HTML tag indicative of the at least one image embedded in the text.
